(19) United States
(12) Patent Application Publication
(10) Pub. No.: US 2005/0206154 A1
(43) Pub. Date: Sep. 22, 2005

(54) Notebook with wire guard

(76) Inventors: Dana Marie Walker, Dayton, OH (US); Edward Paul Busam, Mason, OH (US); Stephen Donald Wehmeyer, Cincinnati, OH (US)

Correspondence Address: MARK P. LEVY, ESQ.;THOMPSON HINE LLP, 2000 COURTHOUSE PLAZA NE, 10 W. SECOND STREET, DAYTON, OH, 45402-1758, US

(21) Appl. No.: 10/803,729

(22) Filed: Mar. 18, 2004

(51) Int. Cl. B42D 1/00

(52) U.S. Cl. 281/24

(57) ABSTRACT

A notebook with a wire guard including a front cover having a plurality of openings located generally adjacent to a binding edge of the front cover, a back cover having a plurality of openings located adjacent to a binding edge of the back cover, and a plurality of sheets of paper. Each sheet of paper a plurality of openings located adjacent to a binding edge thereof. The notebook further includes a generally helical binding coil having a plurality of turns, and each of the plurality of openings of the front cover, back cover, and the plurality of sheets of paper receives a turn of the coil therethrough to bind the front cover, back cover and plurality of sheets of paper together. A wire guard having a first edge and a second edge is attached to the notebook such that the first edge is fixedly attached to the front cover generally adjacent to the binding edge of the front cover and the second edge is fixedly attached to the back cover generally adjacent to the binding edge of the back cover such that the binding guard generally covers an exposed portion of the binding coil.

### BACKGROUND

The present invention relates to notebooks and, more particularly, to notebooks having a protective guard covering the notebook binding.

Notebooks are typically used in the home, classroom and office for various purposes, such as for keeping writings and notes organized in a single location. A notebook typically includes a front cover and a back cover with a plurality of sheets of paper positioned therebetween. A binding element, such as a coil, binds the front cover, the back cover and the plurality of sheets of paper together along a binding edge. The binding coil allows a user to open and close the notebook exposing various individual sheets of paper. However, the binding coil of most notebooks is exposed so that the binding coil may become damaged, or conversely, the binding coil may damage other items. Also, the exposed binding coil may present an uncomfortable surface for gripping and carrying.

A notebook with a wire guard that utilizes a twin-wire binding element is known. The twin-wire binding element is used because of the difficulty in assembling a notebook having a wire guard attached to the front and back cover. In particular, a twin-wire binding element may not be a fully closed binding element. For example, the twin-wire binding element may be generally “C” shaped in end view and does not form a closed shape in end view.

In order to mount the twin-wire binding element of such a notebook, the front and back covers of the notebook are aligned. The twin-wire binding element is then spread open such that the end prongs of the “C” shape can be passed through the aligned holes of the front and back covers. The twin-wire binding element is then clamped in a nearly-closed position such that the “C” shape is nearly closed.

However, twin-wire binding elements have many disadvantages due to the open edge that is created with a twin-wire binding. One disadvantage is that sheets of paper and/or the covers can be separated from the binding element via the open point of the nearly closed “C” shape. Another disadvantage is that a notebook using a twin-wire binding element does not open as easily, and rotation about the binding element is not as free as compared to a notebook bound with a helical coil binding mechanism.

Accordingly, there is a need for a notebook which has a helical binding mechanism and a protective cover over the helical binding mechanism.

### SUMMARY

The present invention is a notebook having a protective wire guard covering the binding coil of the notebook. In one embodiment of the present invention, the notebook includes a front cover having a plurality of openings located adjacent to a binding edge of the front cover, a back cover having a plurality of openings located generally adjacent to a binding edge of the back cover, and a plurality of sheets of paper, each sheet having a plurality of openings located generally adjacent to a binding edge of the sheets of paper. The notebook further includes a generally helical binding coil having a plurality of turns, wherein each of the plurality of openings of the front cover, the back cover, and the plurality of sheets of paper receive a turn of the coil therethrough to bind the front cover, back cover, and plurality of sheets of paper. The notebook further includes a wire guard having a first edge and a second edge, wherein the first edge is fixedly attached to the front cover generally adjacent to the binding edge of the front cover and the second edge is fixedly attached to the back cover generally adjacent to the binding edge of the back cover such that the wire guard generally covers the exposed portion of the generally helical binding coil.

Other objects and advantages of the present invention will be apparent from the following description, accompanying drawings, and the appended claims.

### BRIEF DESCRIPTION OF THE DRAWINGS

The invention can be best understood with reference to the following drawings. In the drawings, like reference numerals designate corresponding parts throughout the several views.

FIG. 1 is a side elevational view of one embodiment of the notebook of the present invention;

FIG. 2 is a top perspective view of the notebook of FIG. 1;

FIG. 3 is a top perspective view of the notebook of FIG. 1 with the front cover open;

FIG. 4 is a top perspective view of the notebook of FIG. 1 with the back cover open; and

FIG. 5 is a front perspective view of a portion of the notebook of FIG. 1 with the covers folded back and the binding coil partially wound into the notebook.

### DETAILED DESCRIPTION

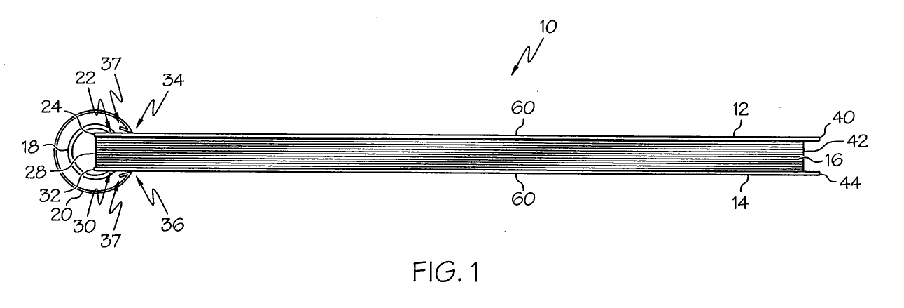

With reference to FIG. 1, the notebook of the present invention, generally designated 10, includes a front cover 12, a back cover 14, and a plurality of sheets of paper 16. The notebook 10 is bound together by a helically shaped binding coil 18 and includes a wire guard 20 covering the exposed portion of the binding coil 18.

The front cover 12, back cover 14 and plurality of sheets of paper 16 may be generally rectangular in shape and comprised of a cellulose based material, or other paper-like material, on which a user can make markings such as by ink, paint, pencil, or other like instruments. The front cover 12 and the back cover 14 may alternatively be made of a polymeric material such as plastic (i.e., polypropylene) and may have a thickness of between about 0.010 and about 0.050 inches, or alternatively between about 0.003 and about 0.100 inches. The front cover 12 and back cover 14 may each have a thickness and/or stiffness greater than that of the plurality of sheets of paper 16 and may serve to protect the plurality of sheets of paper 16.

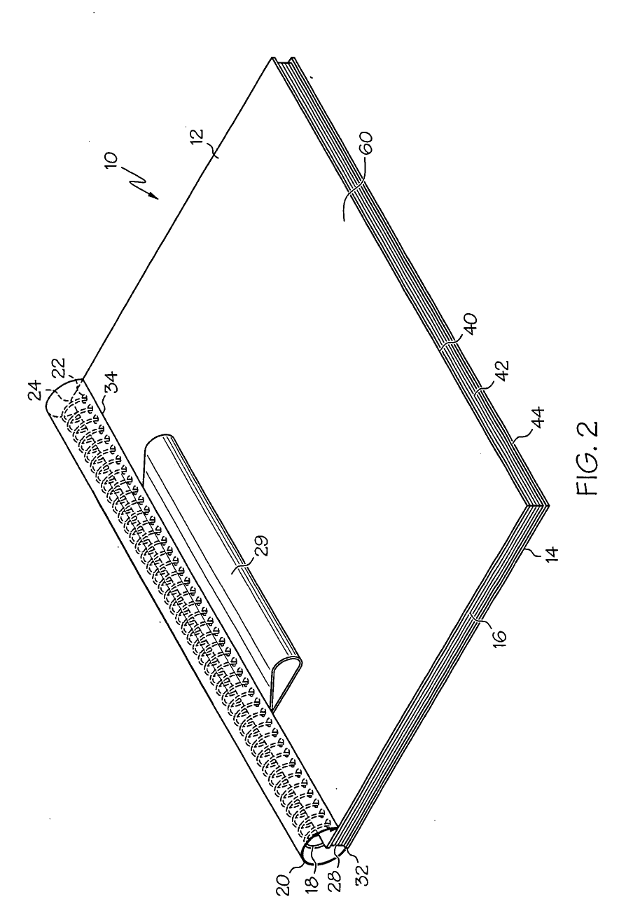

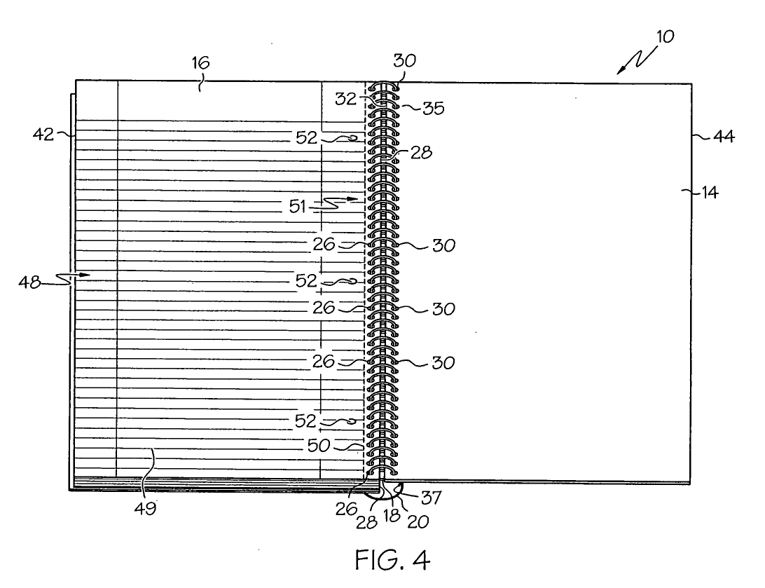

With reference to FIGS. 2-4, the front cover 12 includes an inner or binding edge 24 and has a number of holes or openings 22 extending therealong. Each of the plurality of sheets of paper 16 has an inner or binding edge 28 and also includes a number of holes or openings 26 extending along the binding edge 28. The back cover 14 includes an inner or binding edge 32 and has a number of holes or openings 30 extending along the binding edge 32 of the back cover 14. The holes 22, 26, 30 are evenly spaced along and located adjacent to the associated binding edges 24, 28, 32. In a first embodiment of the present invention, there are at least ten (10) holes 22, 26, 30 arranged generally linearly to form a line that is generally parallel to, and extends along, the binding edges 24, 28, 32.

The helical binding coil 18 may be made of or include a single piece of material, such as a metallic wire formed in a helical or coil shape. The helical binding coil 18 may include a plurality of turns with each turn including a 360-degree section of the coil 18. The helical binding coil 18 may be generally circular (or form a closed shape) in end view. In this manner the helical binding coil 18 lacks an opening through which the papers 16 or covers 12, 14 can escape, and allows the papers 16 and covers 12, 14 to smoothly pivot about the helical binding coil 18 when opening or closing the notebook 10.

The notebook 10 may include a wire guard 20 which may be made of a generally flat, rectangular piece of material having a first longitudinal edge 34 and a second longitudinal edge 36. The first edge 34 is attached to the front cover 12 along or adjacent to the binding edge 24 (but inwardly of the set of holes 22) and the second edge 36 is attached to the back cover 14 along or adjacent to the binding edge 32 (but inwardly of the set of holes 30). As shown in FIG. 1, the wire guard 20 may include a pair of flap portions 37 that are folded generally flat against each cover 12, 14 to form a two-ply thickness of the wire guard 20. The two-ply thickness may result from the process by which the wire guard 20 is attached to the covers 12, 14 as will be discussed below. The wire guard 20 may be made of a flexible polymeric material such as 300 D polyester with a polyvinylchloride (PVC) coating. However, other materials, preferably generally flexible materials, such as fabric, plastics, etc. may be used.

The wire guard 20 is sized and shaped and attached to the front 12 and back 14 covers such that the wire guard 20 is pulled tight against the binding coil 18 when the notebook 10 is closed (i.e., the front 12 and back 14 covers are generally parallel and facing each other with the set of papers 16 therebetween). The wire guard 20 may be attached to the front 12 and back 14 covers by stitching 35 as well as by other attachment methods, including lamination and adhesion. The stitches 35 may extend through the flap portions 37. The wire guard is attached to the front cover 12 and back cover 14 generally along the binding edge of the front cover 24 and the back cover 32 near the openings 22 and 30. The wire guard 20 is attached so that it extends generally the length of the binding edges 24, 28, 32 of the front cover 12, back cover 14, and plurality of sheets of paper 16, and generally covers the entire length of the binding coil 18.

As shown in FIG. 2, the notebook 10 may include a storage loop 29 for storing pens, pencils and other writing instruments therein. The loop 29 may be attached to the wire guard 20, or the front or back covers 12, 14 or both the wire guard 20 and a cover 12, 14. The loop 29 may be attached in any of a wide variety of manners, including by stitches. The loop 29 may be made of an elastic material, the same material the wire guard 20 is made of, or any other like material. The loop 29 may extend the length of the wire guard 20 or only a portion of the length of the wire guard 20.

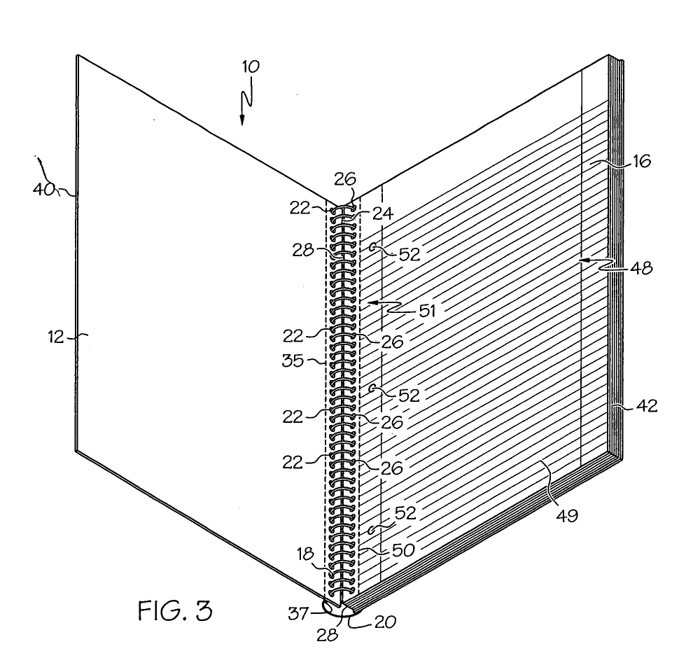

The front cover 12, back cover 14, and plurality of sheets of paper 16 may have generally the same size and shape and may be bound such that they are generally aligned. The notebook 10 may be opened by grasping a free edge 40 of the front cover 12, a free edge 42 of the plurality of sheets of paper 16, or a free edge 44 of the back cover 14, and rotating the appropriate free edge about the binding coil 18. FIG. 3 illustrates the notebook 10 with the front cover 12 opened to expose the writing surface 48 of one of the plurality of sheets of paper 16. The writing surface 48 may include a number of ruled lines 49. The ruled lines 49 may be college ruled (i.e., about 9/32 of an inch apart), wide ruled (i.e., about 11/32 of an inch apart), or have various other configurations. Each of the plurality of sheets of paper 16 may include three holes 52 along the binding edge 28 such that individual pages may be torn at perforations 50 and placed into a three-ring binder. The perforations 50 form a tear guideline 51 extending generally parallel to the binding edge 28 of each of the plurality of sheets of paper 16.

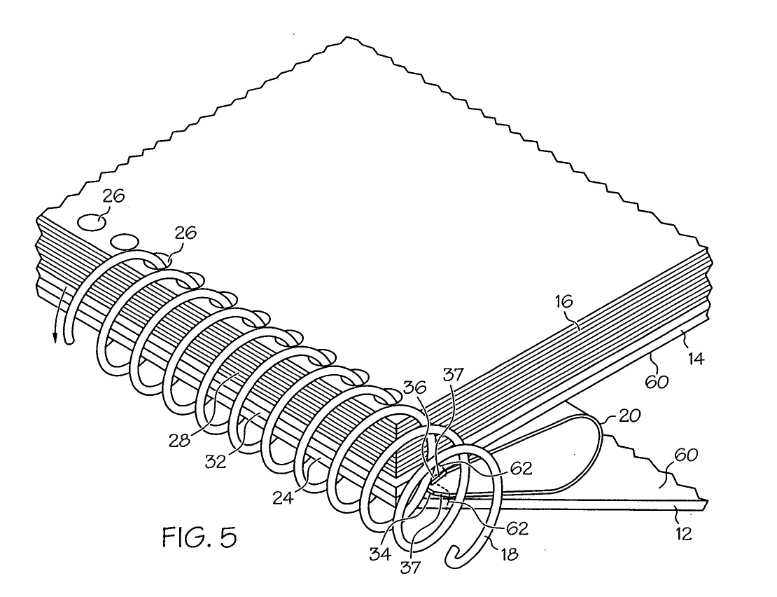

The notebook 10 is assembled by first arranging the covers 12, 14 in an “inside out” configuration such that the outer surfaces 60 of the front 12 and back 14 covers are facing each other. The wire guard 20 is then located between the covers 12, 14 and attached to the covers 12, 14, for example by stitching 62 that extends through the covers 12, 14 and the wire guard 20, which thereby creates or defines the flap portions 37. Alternatively, the stitching 62 may pass through the wire guard 20 and into the front surface 60 of the covers 12, 14, in which case the stitching 62 may extend only partially through the thickness of the covers 12, 14 or completely through the covers 12, 14. The resultant assembly of covers 12, 14 and wire guard 20 can be seen in FIG. 5, wherein the covers 12, 14 are generally parallel and facing each other, and the wire guard 20 is folded upon itself. This method of attaching the wire guard 20 provides a clean seam, hidden stitches that are not visible when the notebook 10 is in its closed position, as seen in FIG. 1.

The plurality of sheets of paper 16 may then be positioned on top of the front and back covers 12, 14, as shown in FIG. 5, such that the holes 26 in the sheets of paper are aligned with the holes 22, 30 in the front and back covers 12, 14. The helical binding coil 18 may then be manually wound through the holes 22, 26, 30, as indicated by the arrow in FIG. 5, to bind the notebook 10 together. Once the binding coil 18 is fully wound onto the notebook 10, the notebook 10 may be moved to its closed position shown in FIG. 1. Alternatively, an automated process may be used to wind the helical binding coil 18 through the holes 22, 26, 30.

Although the invention is shown and described with respect to certain embodiments, it is obvious that equivalents and modifications will occur to those skilled in the art upon reading an understanding the specification. The present invention includes all such equivalents and modifications and is limited only by the scope of the claim.

1. A coil bound notebook comprising:
a front cover having a plurality of openings located generally adjacent to a binding edge of said front cover;
a back cover having a plurality of openings located generally adjacent to a binding edge of said back cover;
a plurality of sheets of paper each having a plurality of openings located generally adjacent to a binding edge thereof;
a generally helical binding coil having a plurality of turns, wherein each of said plurality of openings of said front cover, said back cover, and said plurality of sheets of paper receives a turn of said coil therethrough to bind said front cover, said back cover, and said plurality of sheets of paper together; and
a coil guard having a first edge and a second edge, wherein said first edge is fixedly attached to said front cover generally adjacent to said binding edge of said front cover and said second edge is fixedly attached to said back cover generally adjacent to said binding edge of said back cover such that said coil guard generally covers an exposed portion of said binding coil.

2. The coil bound notebook of claim 1 wherein said front cover, said back cover, and said plurality of sheets of paper are each generally rectangular in front view and are generally aligned.

3. The coil bound notebook of claim 2 wherein each of said front cover, back cover, and plurality of sheets of paper include a free edge oriented generally parallel to the associated binding edge and located on an opposite side thereof.

4. The coil bound notebook of claim 1 wherein each of said plurality of sheets of paper includes a cellulose based material.

5. The coil bound notebook of claim 1 wherein each of said plurality of sheets of paper includes a tear guide line extending generally parallel to said binding edge.

6. The coil bound notebook of claim 5 wherein each of said plurality of sheets of paper includes three holes located generally adjacent to said binding edge and located generally inwardly of said tear guide line.

7. The coil bound notebook of claim 1 wherein said plurality of openings on said front cover, said back cover, and said plurality of sheets of paper each include at least ten openings arranged generally linearly to form a line that is generally parallel to, and extends along, said associated binding edge.

8. The coil bound notebook of claim 7 wherein each opening of one of said front cover, back cover, or plurality of sheets of paper are spaced from one another by a uniform distance.

9. The coil bound notebook of claim 1 wherein said coil guard is attached to said front cover and said back cover by stitches extending through said coil guard and at least partially through the associated one of said front or back cover.

10. The coil bound notebook of claim 1 wherein said notebook is moveable to a closed position such that said front cover and said back cover are generally parallel and facing each other and wherein said plurality of sheets of paper are located therebetween.

11. The coil bound notebook of claim 10 wherein said coil guard is pulled tight against said helical binding coil when said notebook is in said closed position.

12. The coil bound notebook of claim 1 wherein said front cover and said back cover each have at least one of a thickness or stiffness that is greater than a sheet of said plurality of sheets of paper.

13. The coil bound notebook of claim 1 wherein said coil guard extends generally an entire length of said binding edge of said front cover and said back cover.

14. The coil bound notebook of claim 1 wherein said coil guard is generally flexible.

15. The coil bound notebook of claim 1 further comprising a loop shaped to receive a writing instrument therethrough and coupled to at least one of said front cover, back cover or coil guard.

16. The coil bound notebook of claim 1 wherein said binding coil is a generally continuous single element formed in a helical shape.

17. The coil bound notebook of claim 1 wherein said first edge and said second edge of said coil guard are generally not visible when said notebook is in a closed position such that said front cover and back cover are generally parallel and facing each other with said plurality of sheets located between to provide a hidden seam.

18. A method for making a notebook comprising the steps of:
providing a front cover having a plurality of openings located generally adjacent to a binding edge of said front cover;
providing a back cover having a plurality of openings located generally adjacent to a binding edge of said back cover;
providing a plurality of sheets of paper having a plurality of openings located generally adjacent to a binding edge of said plurality of sheets of paper;
attaching a coil guard to said front cover and said back cover such that a first edge of said coil guard is attached generally adjacent to said binding edge of said front cover and a second edge of said coil guard is attached generally adjacent to said binding edge of said back cover;
positioning said plurality of sheets of paper adjacent to at least one of said front cover and said back cover such that said plurality of openings of said front cover, said back cover, and said plurality of sheets of paper are aligned; and
screwing a generally helical binding coil through said plurality of openings of said front cover, said back cover, and said plurality of sheets of paper.

19. The method of claim 18 wherein said screwing step is accomplished manually.

20. The method of claim 18 wherein said front cover, said back cover, and said plurality of sheets of paper are each generally rectangular in front view and are generally aligned during said screwing step.

21. The method of claim 18 wherein each of said front cover, back cover, and plurality of sheets of paper include a free edge oriented generally parallel to the associated binding edge and located on an opposite side thereof after said screwing step.

22. The method of claim 18 wherein each of said plurality of sheets of paper includes a cellulose based material.

23. The method of claim 18 wherein each of said plurality of sheets of paper includes a tear guide line extending generally parallel to said binding edge.

24. The method of claim 23 wherein each of said plurality of sheets of paper includes three holes located generally adjacent to said binding edge and located generally inwardly of said tear guide line.

25. The method of claim 18 wherein said plurality of openings on said front cover, said back cover, and said plurality of sheets of paper each include at least ten openings arranged generally linearly to form a line that is generally parallel to, and extends along, said associated binding edge.

26. The method of claim 18 wherein each of said plurality of openings of one of said front cover, back cover, or plurality of sheets of paper are spaced from one another by a uniform distance.

27. The method of claim 18 wherein said coil guard is attached to said front and back cover by stitches extending through said coil guard and at least partially through the associated one of said front or back cover.

28. The method of claim 18 wherein after said screwing step said notebook is moveable to a closed position such that said front cover and said back cover are generally parallel and facing each other and wherein said plurality of sheets of paper are located therebetween.

29. The method of claim 28 wherein said coil guard is pulled tight against said helical binding coil when said notebook is in said closed position.

30. The method of claim 18 wherein said front cover and said back cover each have at least one of a thickness or stiffness that is greater than a sheet of said plurality of sheets of paper.

31. The method of claim 18 wherein said coil guard extends generally an entire length of said binding edge of said front cover and said back cover.

32. The method of claim 18 wherein said coil guard is generally flexible.

33. The method of claim 18 wherein said attaching step includes attaching a loop shaped to receive a writing instrument therethrough to at least one of said front cover, back cover or coil guard.

34. The method of claim 18 wherein said binding coil is a generally continuous single element formed in a helical shape.

35. The method of claim 18 wherein said binding coil is a wire.

36. The method of claim 18 wherein said positioning step includes arranging said front and rear covers such that said front and rear covers are generally facing each other and said coil guard is generally located between said covers.

37. The method of claim 36 wherein said coil guard is generally folded upon itself when said front and rear covers are generally facing each other and said coil guard is generally located between said covers.

38. The method of claim 36 wherein said positioning step includes positioning said plurality of sheets of paper on one of said front or rear covers
